(19) United States
(12) Patent Application Publication
(10) Pub. No.: US 2018/0255276 A1
(43) Pub. Date: Sep. 6, 2018

(54) SYSTEM AND METHOD FOR MONITORING VEHICLE

(71) Applicant: Shanghai Xiaoyi Technology Co., Ltd., Shanghai (CN)

(72) Inventors: Jie SHOU, Beijing (CN); Yangcun CHEN, Beijing (CN); Yanfeng HUANG, Beijing (CN)

(73) Assignee: Shanghai Xiaoyi Technology Co., Ltd.

(21) Appl. No.: 15/908,949

(22) Filed: Mar. 1, 2018

(30) Foreign Application Priority Data
Mar. 2, 2017 (CN) 201710120246.6

(51) Int. Cl. H04N 7/18; B60R 1/00; H04N 5/232; G06K 9/00

(52) U.S. Cl. CPC H04N 7/185; B60R 1/00; H04N 5/23251; B60R 2300/8073; G06K 9/00832; B60R 2300/105; G06K 9/00791

(57) ABSTRACT

System and method for remotely monitoring vehicle condition include a method performed by a driving recorder. The method includes, in response to receiving a monitoring request from a mobile terminal paired with the driving recorder, controlling a camera array of the driving recorder to generate real-time image data. The method also includes transmitting the real-time image data to the mobile terminal over a network connection.

### CROSS-REFERENCE TO RELATED APPLICATION

This application is based upon and claims priority from Chinese Patent Application No. 201710120246.6, filed on Mar. 2, 2017, the disclosure of which is expressly incorporated herein by reference in its entirety.

### TECHNICAL FIELD

The present disclosure generally relates to smart vehicle technology, and more specifically to a system and method for monitoring a vehicle.

### BACKGROUND

As automobile ownership rapidly increases, a driving recorder has received increasing attention as an important device for ensuring driving safety.

The driving recorder is normally used to record audio and video during the driving process or when the vehicle is parked. Thus, when an accident occurs, or when the vehicle's engine is off and the vehicle is stolen, scratched, scraped, dented, etc., after the user leaves the vehicle, the recording function or the parked vehicle monitoring function of the driving recorder provides supporting evidence to enforce the law and settle claims. Currently, the driving recorder can actively record and push a photograph or video to a mobile terminal of the user when vehicle vibrations occur. However, when the user actively needs to remotely view video of the vehicle's vicinity, the driving recorder requires the user to be physically on-site, which causes inconvenience.

The disclosed methods and systems address one or more of the problems listed above.

### SUMMARY

Consistent with one embodiment of the present disclosure, a method for monitoring vehicle is provided. The method is performed by a driving recorder mounted on a vehicle. The method includes, in response to receiving a monitoring request from a mobile terminal paired with the driving recorder, controlling a camera array of the driving recorder to generate real-time image data. The method also includes transmitting the real-time image data to the mobile terminal over a network connection.

Consistent with another embodiment of the present disclosure, a driving recorder mounted on a vehicle is provided. The driving recorder includes a camera array, a memory storing instructions, and a processor. The processor is configured to execute the instructions to: in response to receiving a monitoring request from a mobile terminal paired with the driving recorder, control the camera array to generate real-time image data; and transmit the real-time image data to the mobile terminal over a network connection.

Consistent with yet another embodiment of the present disclosure, a non-transitory computer-readable storage medium is provided. The medium stores instructions that, when executed by a processor of a driving recorder mounted on a vehicle, cause the driving recorder to perform a method for remotely monitoring vehicle condition. The method includes, in response to receiving a monitoring request from a mobile terminal paired with the driving recorder, controlling a camera array of the driving recorder to generate real-time image data. The method also includes transmitting the real-time image data to the mobile terminal over a network connection.

It is to be understood that both the foregoing general description and the following detailed description are exemplary and explanatory only and are not restrictive of the invention, as claimed.

### DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a remote monitoring method performed by a driving recorder, according to an exemplary embodiment of the present disclosure.

FIG. 2 is a flowchart of a method for pairing a driving recorder with a mobile terminal, according to an exemplary embodiment of the present disclosure.

FIG. 3 is a flowchart of a method for pairing a driving recorder with a mobile terminal, according to an exemplary embodiment of the present disclosure.

FIG. 4 is a flowchart of step S11 shown in FIG. 1, according to an exemplary embodiment of the present disclosure.

FIG. 5 is a schematic diagram illustrating an application scenario of the disclosed remote monitoring method, according to an exemplary embodiment of the present disclosure.

FIG. 6 is a block diagram of a remote monitoring apparatus, according to an exemplary embodiment of the present disclosure.

FIG. 7 is a block diagram of an obtaining module 61 shown in FIG. 6, according to an exemplary embodiment of the present disclosure.

FIG. 8 is a block diagram of a pairing module 65 shown in FIG. 6, according to an exemplary embodiment of the present disclosure.

FIG. 9 is a block diagram of a driving recorder, according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

A driving recorder is normally used to record audio and video during the driving process, thus providing supporting evidence to enforce the law and settle claims when an accident occurs. Specifically, during the driving process, it conducts audio and video recording, i.e. records video, records audio, and photographs, and at the same time stores the recordings in a memory card in the driving recorder.

Further, the driving recorder is used when the vehicle is parked and the vehicle's engine is off to monitor whether the vehicle is stolen, scratched, scraped, dented, etc., after the user has left the vehicle. The main categories of parked vehicle monitoring methods currently available are as follows:

1. When the vehicle is parked and the vehicle's engine is off, the camera of the driving recorder remains in a continuously on state to monitor the scene; when a rather large change of the scene on the camera is detected, a fixed-length video is recorded and stored in the memory card in the driving recorder. The aforementioned method is called parked vehicle monitoring via “motion surveillance.”

2. When the vehicle is parked and the vehicle's engine is off, photographs are taken by the camera of the driving recorder at fixed time intervals (e.g. 30 seconds), and then a short video clip is composed from all of the collected photographs within a fixed period (e.g. 1 hour) through software composition and is stored in the memory card in the driving recorder. The aforementioned method is called parked vehicle monitoring via “short video generated from photographs taken at fixed times.”

3. When the vehicle is parked and the vehicle's engine is off, the driving recorder maintains a low-power sleep state. When the accelerometer detects vehicle vibrations, the camera module and the network communication module are awakened; a fixed-length emergency video is recorded and a photograph of the scene is taken through the camera; the emergency video recording is stored in the memory card in the driving recorder; and a photograph of the scene or an alert is pushed to the owner of the vehicle by the network communication module via wireless network in the form of text message, multimedia message, or photograph of the scene.

However, when the user actively needs to view video of the vehicle's vicinity, for example when the user suspects property or packages are left in the vehicle or when the user worries that the vehicle's windows are not closed on a rainy day, and when the user needs to remotely view the inside and outside of the vehicle, the aforementioned prior art cannot meet the user's need and requires the user to be physically on-site, which causes inconvenience.

Through research, the inventor of the present disclosure has discovered: all technologies provided by the prior art are one-way push methods. The driving recorder can only store recorded audio and video material, or send the obtained material to the user in a one-way push when vehicle vibrations occur; the driving recorder cannot send the material to the user in real-time when the user actively needs to view video of the vehicle's vicinity.

In one embodiment of the present disclosure, real-time video from a camera array of the driving recorder is obtained in response to a monitoring request sent from a mobile terminal paired with the driving recorder; and the real-time video is transmitted to the mobile terminal over a network connection. This solution can obtain the user's monitoring request through the mobile terminal paired with the driving recorder to learn that the user has a need to actively view video of the vehicle's vicinity. This solution then transmits real-time video recorded by the driving recorder to the user over a network connection, meeting the user's need to remotely monitor real-time video of the vehicle's vicinity and providing increased convenience.

In order to make the aforementioned purpose, characteristics, and benefits of the present disclosure more evident and easier to understand, detailed descriptions are provided below of specific exemplary embodiments of the present disclosure in reference to the drawings attached.

FIG. 1 is a flowchart showing a remote monitoring method for a driving recorder in one exemplary embodiment of the present disclosure. The remote monitoring method comprises steps S11 through S12.

Step S11: real-time video from the camera array of the driving recorder is obtained in response to a monitoring request sent by the mobile terminal paired with the driving recorder.

Step S12: the real-time video is transmitted to the mobile terminal over a network connection.

In a specific embodiment of step S11, the user's need to actively view video in the vehicle's vicinity is known based on the monitoring request sent by the mobile terminal paired with the driving recorder; real-time video is then recorded through the camera array.

Here, the camera array may comprise a plurality of cameras, and the plurality of cameras comprise cameras inside the vehicle to record video inside the vehicle and/or cameras outside the vehicle to record video outside the vehicle. The specific need of the user to view video inside and outside the vehicle is met through the aforementioned camera array.

Further, in order to ensure that the driving recorder can only be remotely monitored by permitted users, the driving recorder is paired with the mobile terminal in advance.

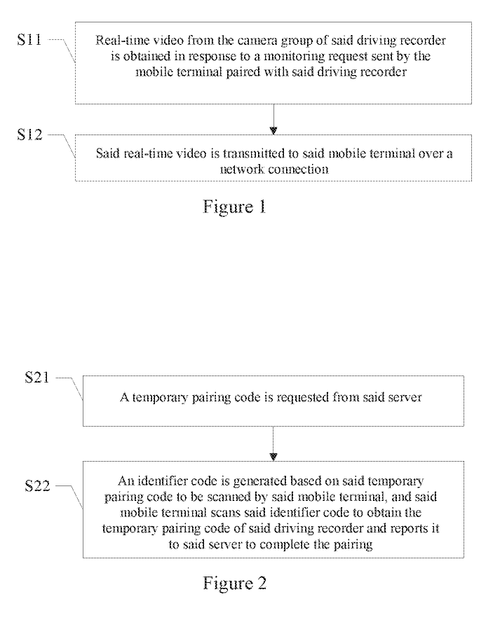

FIG. 2 is a flowchart showing a method for pairing of the driving recorder with the mobile terminal in one embodiment example of the present disclosure. The method comprises steps S21 through S22.

Step S21: a temporary pairing code is requested from the server.

Step S22: an identifier code to be scanned by the mobile terminal is generated based on the temporary pairing code, and the mobile terminal scans the identifier code to obtain the temporary pairing code of the driving recorder and reports it to the server to complete the pairing.

In a specific embodiment of step S21, the temporary pairing code may be requested and obtained from the server by the driving recorder.

In a specific embodiment of step S22, the driving recorder generates an identifier code based on the temporary pairing code; the identifier code may be a two-dimensional barcode, a barcode, an International Mobile Equipment Identity (IMEI), or other types of codes, which is scanned by the mobile terminal and used by the mobile terminal to correctly identify the driving recorder.

Further, the mobile terminal scans the identifier code to obtain the temporary pairing code of the driving recorder and then reports it to the server to complete pairing with the support of the server.

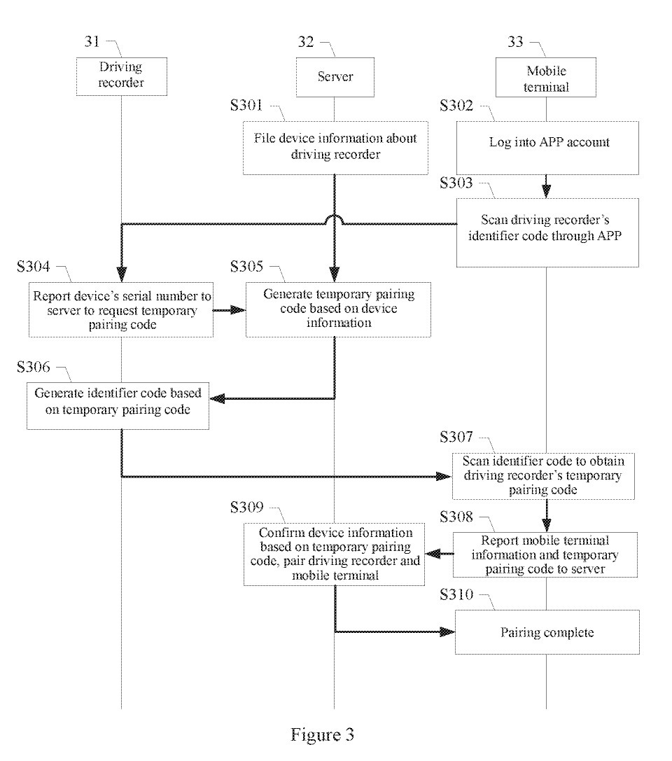

FIG. 3 is an information flow diagram showing a method for pairing of the driving recorder with the mobile terminal in one embodiment example of the present disclosure. The method for pairing of the driving recorder with the mobile terminal comprises steps S301 through S310. A detailed description of each of the steps is provided below.

Step S301: the device information of a driving recorder 31 is filed with a server 32.

Step S302: an Application (APP) account is logged into through a mobile terminal 33.

Step S303: the mobile terminal 33 scans the identifier code of the driving recorder 31 through the APP. Here, the identifier code may be a two-dimensional barcode, a barcode, an International Mobile Equipment Identity (IMEI), or other types of codes.

Step S304: the driving recorder 31 reports the serial number of the device to the server 32 in order to request the temporary pairing code.

Step S305: the server 32 generates the temporary pairing code based on the device information of the driving recorder 31.

Step S306: the driving recorder 31 generates the identifier code based on the temporary pairing code.

Step S307: the identifier code is scanned by the mobile terminal 33 to obtain the temporary pairing code of the driving recorder 31.

Step S308: the mobile terminal 33 reports the mobile terminal information and the temporary pairing code to the server 32.

Step S309: the server 32 confirms the device information based on the temporary pairing code and pairs the corresponding driving recorder 31 with the mobile terminal 33.

Step S310: the pairing between the driving recorder 31 and the mobile terminal 33 is complete.

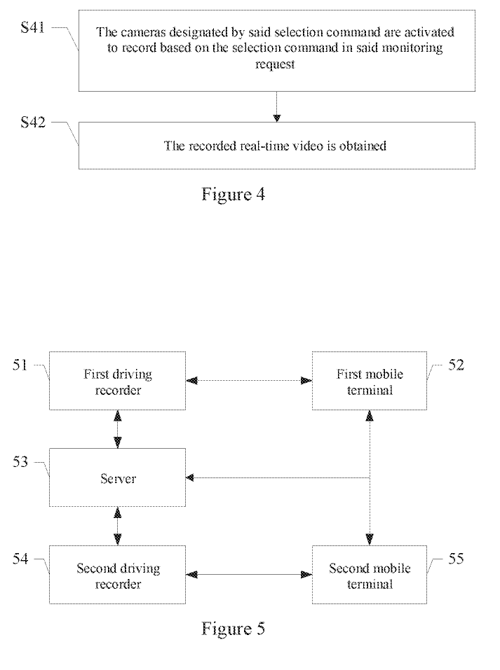

FIG. 4 is a flowchart of a specific embodiment of step S11 in FIG. 1. The method comprises steps S41 through S42. A detailed description of each of the steps is provided below.

Step S41: the cameras designated by a selection command are activated to record based on the selection command in the monitoring request. Specifically, the user may select the area and location needed for remote monitoring based on actual need. For example, when the user needs to monitor video inside the vehicle because the user suspects that property is left in the vehicle, the user may send a selection command to request to monitor cameras inside the vehicle; when the user needs to monitor video outside the vehicle because the user worries that the vehicle has come into contact with an object in the vehicle's vicinity that may have scratched or scraped the vehicle, the user may send a selection command to request to monitor cameras outside the vehicle, including the front cameras, the rear cameras, and the side cameras.

Further, when the vehicle's engine is off, the driving recorder may automatically enter a low-power sleep mode that stops the camera array from working, achieving the purpose of saving energy. When a monitoring request sent by the mobile terminal is received, the cameras that the user designated are activated to record based on the selection command in the monitoring request, and the other cameras from the camera array that were not designated by the user still remain in a non-working state.

Step S42: the recorded real-time video is obtained. Specifically, in response to the recording by the cameras designated by the user, the video from the cameras is obtained in real time.

Continuing to refer to FIG. 1, in a specific embodiment of step S12, the real-time video from the cameras is transmitted to the mobile terminal over a network connection in order for the user to remotely view the area and location that the user needs to monitor in real time.

Further, the network connection can be a peer-to-peer (P2P) connection established between the driving recorder and the mobile terminal.

Specifically, the driving recorder continues to maintain a low frequency “long connection” with the server when the network runs smoothly. For example, online status updates are sent to the server at fixed time intervals to ensure that the server confirms that the driving recorder can be connected to the mobile terminal, so that when the mobile terminal issues a monitoring request, a network connection will be established between the driving recorder and the mobile terminal with the support of the server.

Furthermore, the peer-to-peer (P2P) connection may be established on various networks such as 5G, 4G, 3G, 2G, etc., and it may also be established on a wireless local area network (WiFi); understandably, any network that uses wireless electromagnetic waves as a transmission medium may be used as a basis for the establishment of the P2P connection in the exemplary embodiment of the present disclosure. No redundant description will be detailed here.

FIG. 5 is an application scenario diagram of a remote monitoring method for the driving recorder in one exemplary embodiment of the present disclosure.

As described earlier, a first mobile terminal 52 can complete the pairing with a first driving recorder 51 with the support of a server 53; and the pairing between a second mobile terminal 55 and a second driving recorder 54 can be completed in the same manner.

Further, the first driving recorder 51 and the second driving recorder 54 can be connected to the server 53 through 3G/4G, respectively, to enable each driving recorder to send its online status to the server 53, so that the server 53 confirms that the aforementioned driving recorders can be connected to the mobile terminal. It should be noted that the connection path between each driving recorder and the server 53 is by no means limited to 3G/4G, and it can use other networks. For example, when one of the driving recorders is connected to WiFi but does not have a SIM card inserted, a remote connection with the server 53 and a network connection with the mobile terminal can be achieved through WiFi; when one of the driving recorders has a SIM card inserted and can use mobile traffic, that driving recorder can achieve a remote connection with the server 53 and a network connection with the mobile terminal through networks such as 5G, 4G, 3G, 2G, etc.

When the first mobile terminal 52 sends a monitoring request, a P2P connection between the first driving recorder 51 and the first mobile terminal 52 can be established with the support of the server 53. Information exchange between the first driving recorder 51 and the first mobile terminal 52 can be achieved through the network connection that has been established, and the specific remote connection path can be the path for any of the aforementioned P2P connections. In the same manner, information exchange between the second driving recorder 54 and the second mobile terminal 55 can also be achieved through P2P connection.

It should be noted that when the first mobile terminal 52 or the second mobile terminal 55 sends a monitoring request, the monitoring request is first sent to the server 53 and is forwarded to the driving recorder paired with the mobile terminal via the server 53.

Understandably, the server 53 and the aforementioned server that supports the completion of the pairing between the mobile terminal and the driving recorder can be the same server, or they can be separate servers that enable the pairing and data exchange, respectively; the embodiment example of the present disclosure does not place restrictions on the number of servers or the functions enabled by each specific server.

Referring back to FIG. 1, in a specific embodiment of step S12, the real-time video recorded by the driving recorder is transmitted to the user over the network connection, meeting the user's need to remotely monitor real-time video of the vehicle's vicinity and providing increased convenience.

Further, when the real-time video is transmitted to the mobile terminal, the vehicle's positioning information is transmitted to the mobile terminal over the network connection. When using the solution provided by this exemplary embodiment of the present disclosure, the user's need to learn of the vehicle's location in real time can be met, and the chance that the user discovers abnormalities in the vehicle's location in a timely manner is increased.

In another exemplary embodiment of the present disclosure, it is also possible to transmit alarm information and the vehicle's positioning information to the mobile terminal in response to the vehicle vibrations detected by an accelerometer.

Specifically, in the prior art, when a vehicle is parked and the vehicle's engine is off, the accelerometer remains in a working state in order to confirm in real time whether vehicle vibrations are occurring by monitoring acceleration values in real time. When vehicle vibrations are detected, the driving recorder can connect to the server through a wireless communication module to process data, and can transmit alarm information to a server; and the server immediately pushes the alarm information to the mobile terminal paired with the driving recorder. However, in an exemplary embodiment of the present disclosure, the driving recorder not only transmits alarm information via the server, it can also transmit positioning information to the mobile terminal via the server.

Here, the alarm information may comprise alarm type, accelerometer values, and other content. The positioning information can be obtained by determining the geographic location through Global Positioning System (GPS) or Location Based Service (LBS).

Further, when vehicle vibrations are detected, the driving recorder can automatically wake the camera module and automatically record a fixed-length emergency video recording; then it can store the emergency video recording, or transmit the video recording to the mobile terminal via the server, or send the video recording to the mobile terminal through the aforementioned network connection between the driving recorder and the mobile terminal.

Compared to the prior art, in which only alarm information is transmitted to the user when vehicle vibrations occur, the solution provided in this exemplary embodiment of the present disclosure can enable the user to also learn about the actual location of the vehicle when the alarm is triggered, and thus increase the probability that the vehicle will be recovered after being stolen.

In this exemplary embodiment of the present disclosure, the user's need to actively view video of the vehicle's vicinity can be known through the user's monitoring request, which is obtained through the mobile terminal paired with the driving recorder; further, the real-time video recorded by the driving recorder is transmitted to the user over a network connection, meeting the user's need to remotely monitor real-time video of the vehicle's vicinity and providing increased convenience.

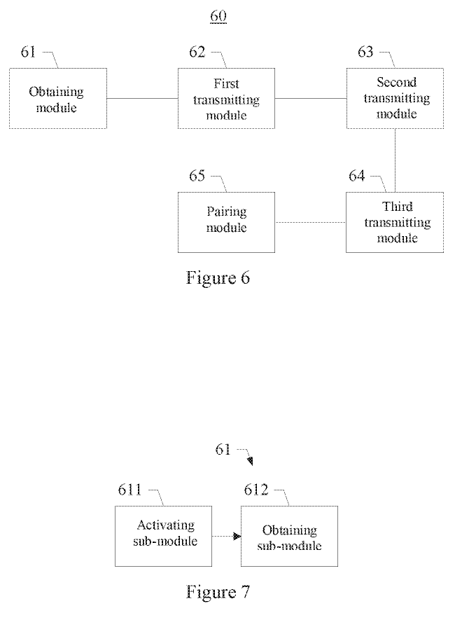

FIG. 6 is a structural diagram of a remote monitoring apparatus 60 for a driving recorder in one exemplary embodiment of the present disclosure. The remote monitoring apparatus 60 comprises an obtaining module 61, a first transmitting module 62, a second transmitting module 63, a third transmitting module 64, and a pairing module 65.

Here, the obtaining module 61 is suitable for obtaining real-time video from the camera array of the driving recorder in response to a monitoring request sent by the mobile terminal paired with the driving recorder.

The first transmitting module 62 is suitable for transmitting the real-time video to the mobile terminal over a network connection.

The second transmitting module 63 is suitable for transmitting the vehicle's positioning information to the mobile terminal over the network connection when the real-time video is transmitted to the mobile terminal.

The third transmitting module 64 is suitable for transmitting alarm information and the vehicle's positioning information to the mobile terminal in response to the vehicle vibrations detected by the accelerometer.

The pairing module 65 is used for pairing the driving recorder with the mobile terminal.

Further, the camera array comprises a plurality of cameras, and the plurality of cameras comprise cameras inside the vehicle to record video inside the vehicle and/or cameras outside the vehicle to record video outside the vehicle.

The network connection is a peer-to-peer connection established between the driving recorder and the mobile terminal.

The monitoring request is forwarded to the driving recorder via the server.

FIG. 7 is a structural diagram of a specific embodiment of the obtaining module 61 in FIG. 6; the obtaining module 61 comprises an activating sub-module 611 and an obtaining sub-module 612.

Here, the activating sub-module 611 is suitable for activating the cameras designated by the selection command to record based on the selection command in the monitoring request. The obtaining sub-module 612 is suitable for obtaining the recorded real-time video.

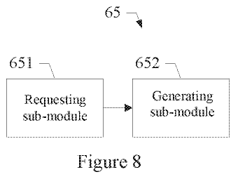

FIG. 8 is a structural diagram of a specific embodiment of the pairing module 65 in FIG. 6. The pairing module 65 comprises a requesting sub-module 651 and a generating sub-module 652.

Here, the requesting sub-module 651 is suitable for requesting a temporary pairing code from the server.

The generating sub-module 652 is suitable for generating an identifier code to be scanned by the mobile terminal based on the temporary pairing code; the mobile terminal scans the identifier code to obtain the temporary pairing code of the driving recorder and reports it to the server to complete the pairing.

Details about the remote monitoring apparatus 60 for a driving recorder, are included in the relevant descriptions of the remote monitoring method for a driving recorder set forth above and in FIG. 1 through FIG. 5. No redundant description will be detailed here.

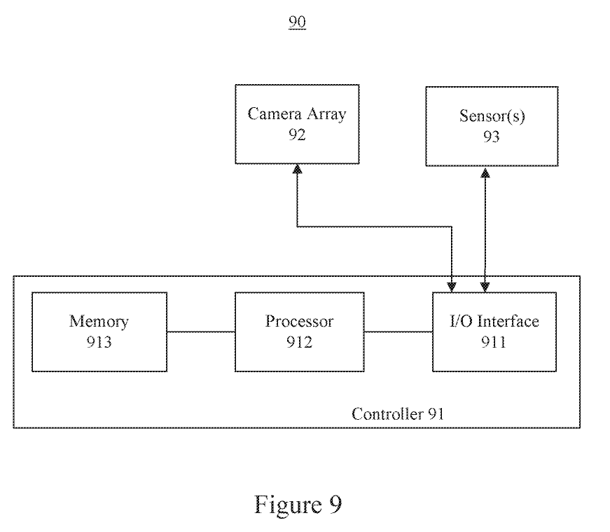

FIG. 9 is a block diagram of a driving recorder 90, according to an exemplary embodiment of the present disclosure. For example, the driving recorder 90 may include a part or the whole of the aforementioned remote monitoring apparatus 60 (FIG. 6). In the disclosed embodiments, the driving recorder 90 is mounted on a vehicle for monitoring conditions inside and outside the vehicle. Referring to FIG. 9, the driving recorder 90 includes a controller 91, a camera array 92, and one or more sensors 93.

In some embodiments, the controller 91 further includes an input/output (I/O) interface 911, a processor 912, and/or a memory 913. These units are configured to transfer data and send or receive instructions between or among each other.

The I/O interface 911 is configured for two-way communication between the controller 91 and various components of the driving recorder 90, such as the camera array 92 and the sensors 93. The I/O interface 911 also sends and receives data to and from a mobile terminal (not shown in FIG. 9). The I/O interface 911 sends and receives data between each of the devices via communication cables, wireless networks, or other communication mediums. For example, the I/O interface 911 is configured to send and receive signals to a mobile terminal via a network (not shown in FIG. 9). The network may be any type of wired or wireless network that allows transmitting and receiving data. For example, the network may be a nationwide cellular network, a local wireless network (e.g., Bluetooth, WiFi, or LiFi), and/or a wired network. The processor 912 is configured to receive signals and process the signals to determine a plurality of conditions regarding the vehicle and the occupants in the vehicle. The processor 912 is also configured to generate and transmit command signals, via the I/O interface 911, in order to actuate the camera array 92 and the sensors 93.

The memory 913 is configured to store one or more computer programs that may be executed by the controller 91 (or the processor 912) to perform functions of the driving recorder 90. For example, the memory 913 stores computer instructions that, when executed by the processor 912, cause the processor 912 to perform the above-described remote monitoring methods. The memory 913 also stores data used or generated by the processor 912 during the performance of the disclosed remote monitoring methods. For example, the data may include image data generated by the camera array 92 and/or sensor data generated by the sensors 93.

In exemplary embodiments, there is also provided a non-transitory computer-readable storage medium including instructions, such as included in the memory 913, executable by the processor 912 to perform the above-described methods. For example, the non-transitory computer-readable storage medium may be a read-only memory (ROM), a random access memory (RAM), a CD-ROM, a magnetic tape, a floppy disc, an optical data storage device, and the like.

The camera array 92 and sensors 93 are coupled to the controller 91 via IO interface 911. The camera array 92 includes cameras inside the vehicle to record video inside the vehicle and/or cameras outside the vehicle to record video outside the vehicle.

Sensors 93 may include an inertial measurement unit (IMU) that provides angular rates and acceleration of the vehicle. In some embodiments, the IMU may be a 6-degree of freedom (6 DOF) IMU that includes a 3-axis accelerometer, a 3-axis angular rate gyros, and sometimes a 2-axis inclinometer. The 3-axis angular rate gyros provides signals indicative of the pitch rate, yaw rate, and roll rate of the vehicle. The 3-axis accelerometer provides signals indicative of the acceleration of the vehicle in the x, y, and z directions.

Notwithstanding the above disclosure of the present disclosure, it does not restrict the present disclosure. Any person of skill in the art may make various alterations and changes that are within the spirit and scope of the present disclosure; therefore, the scope of protection for the present disclosure should be that as defined by the claims.

What is claimed is:

1. A method performed by a driving recorder mounted on a vehicle, comprising:
in response to receiving a monitoring request from a mobile terminal paired with the driving recorder, controlling a camera array of the driving recorder to generate real-time image data; and
transmitting the real-time image data to the mobile terminal over a network connection.

2. The method according to claim 1, wherein the camera array includes at least one of:
a camera located inside the vehicle and configured to capture images inside the vehicle; or
a camera located outside the vehicle and configured to capture images outside the vehicle.

3. The method according to claim 1, wherein:
the camera array includes a plurality of cameras;
the monitoring request includes a camera-selecting instruction; and
controlling the camera array of the driving recorder to generate the real-time image data comprises:
selecting one or more cameras from the camera array based on the camera-selecting instruction; and
activating the selected one or more cameras to capture real-time images.

4. The method according to claim 1, wherein the network connection is a peer-to-peer connection established between the driving recorder and the mobile terminal.

5. The method according to claim 1, further comprising:
transmitting position information of the vehicle to the mobile terminal over the network connection.

6. The method according to claim 1, wherein the driving recorder is coupled with an accelerometer mounted on the vehicle, wherein the method further comprises:
in response to receiving vehicle vibration data from the accelerometer, transmitting alarm information and positioning information of the vehicle to the mobile terminal.

7. The method according to claim 1, wherein the driving recorder receives the monitoring request via a server.

8. The method according to claim 7, wherein the driving recorder and the mobile terminal are paired according to a process including:
requesting a temporary pairing code from the server;
generating an identification code based on the temporary pairing code; and
displaying the identification code, wherein the mobile terminal scans the identification code, determines the temporary pairing code based on the identification code, and reports the temporary pairing code to the server to complete the pairing.

9. A driving recorder mounted on a vehicle, comprising:
a camera array;
a memory storing instructions; and
a processor configured to execute the instructions to:
in response to receiving a monitoring request from a mobile terminal paired with the driving recorder, control the camera array to generate real-time image data; and
transmit the real-time image data to the mobile terminal over a network connection.

10. The driving recorder according to claim 9, wherein the camera array includes at least one of:
a camera located inside the vehicle and configured to capture images inside the vehicle; or
a camera located outside the vehicle and configured to capture images outside the vehicle.

11. The driving recorder according to claim 9, wherein:
the camera array includes a plurality of cameras;
the monitoring request includes a camera-selecting instruction; and
the processor is further configured to execute the instructions to:
select one or more cameras from the camera array based on the camera-selecting instruction; and
activate the selected one or more cameras to capture real-time images.

12. The driving recorder according to claim 9, wherein the network connection is a peer-to-peer connection established between the driving recorder and the mobile terminal.

13. The driving recorder according to claim 9, wherein the processor is further configured to execute the instructions to:
transmit position information of the vehicle to the mobile terminal over the network connection.

14. The driving recorder according to claim 9, wherein the driving recorder is coupled with an accelerometer mounted on the vehicle, wherein the processor is further configured to execute the instructions to:
in response to receiving vehicle vibration data from the accelerometer, transmit alarm information and positioning information of the vehicle to the mobile terminal.

15. The driving recorder according to claim 9, wherein the processor is further configured to execute the instructions to receive the monitoring request via a server.

16. The driving recorder according to claim 15, wherein in pairing the driving recorder with the mobile terminal, the processor is further configured to execute the instructions to:
request a temporary pairing code from the server;
generate an identification code based on the temporary pairing code; and
display the identification code, wherein the mobile terminal scans the identification code, determines the temporary pairing code based on the identification code, and reports the temporary pairing code to the server to complete the pairing.

17. A non-transitory computer-readable storage medium storing instructions that, when executed by a processor of a driving recorder mounted on a vehicle, cause the processor to perform a method comprising:
in response to receiving a monitoring request from a mobile terminal paired with the driving recorder, controlling a camera array of the driving recorder to generate real-time image data; and
transmitting the real-time image data to the mobile terminal over a network connection.
